(19) United States
(12) Patent Application Publication
(10) Pub. No.: US 2011/0231527 A1
(43) Pub. Date: Sep. 22, 2011

(54) METHOD AND APPARATUS FOR CONFIGURATING DEVICES

(76) Inventor: Gregory Herlein, San Francisco, CA (US)

(21) Appl. No.: 12/998,720

(22) PCT Filed: Dec. 26, 2008
(86) PCT No.: PCT/US2008/014043

§ 371 Date: May 24, 2011

(51) Int. Cl. G06F 15/177

(52) U.S. Cl. 709/220

(57) ABSTRACT

A method and apparatus for performing automatic device configuration are disclosed. A portable device contains information relevant to configuration of a second device. The second device obtains the relevant information from the first device, and configures itself according to configuration information obtained based on the relevant information.

### TECHNICAL FIELD

This invention relates to a method and apparatus for configuring devices in a network.

### BACKGROUND

Advertising display systems such as those in a retail network are complex and detailed setup information is needed to ensure proper configuration the systems. In a store with many screens, information regarding the locations of screens in respective departments is required in order to provide the correct video for display on each screen. A ‘screen’ may actually be composed of several discrete devices, including a video display unit such as a flat panel liquid crystal display (LCD) or plasma display, a set top box or other media decoding device, an audio decoder and/or amplifier, speakers, and possibly an interactive device such as a touch screen panel that overlays the display. Each of these discrete components may need to be configured for proper functioning within the system.

At the time of installation or replacement, the configuration details of various components are entered into the system. In conventional systems, these configurations are entered both at the device and in the main video server system. For example, the devices are usually based on internet protocol (IP) networking technology, and thus, need assignments of IP addresses. Normal mainstream networking would use dynamic host configuration protocol (DHCP) to assign an address from a pool of addresses. However, that method does not work in an in-store display system because the system must know the location of each device in the store (e.g., grocery, electronics, pharmacy, etc.). Similarly, other configuration parameters such as default audio volume level of the amplifiers, equalization profiles for the amplifiers, and so on, depend on the system knowing exactly where each device is located.

Current practice depends on previously assigning IP addresses to specific locations and then manually configuring the devices at installation time to match the installation location. Although this approach is relatively simple, it is also time-consuming and susceptible to human errors, which can result in additional installation costs and time delay in installations.

### BRIEF SUMMARY OF THE INVENTION

Embodiments of the present invention provide a method for automatically configuring a device, allowing installations to be done in a shorter time and with reduced human errors.

One embodiment provides a method, which includes: (a) obtaining information from a first device, the information being relevant to configuration of a second device, (b) obtaining configuration information of the second device based on the relevant information of the second device, and (c) configuring the second device according to the configuration information.

Another embodiment provides a system, which includes a first device containing information relevant to configuration of a second device, and the second device for obtaining the relevant information contained in the first device, and for performing self-configuration based at least on the relevant information.

### BRIEF DESCRIPTION OF THE DRAWING

The teachings of the present invention can be readily understood by considering the following detailed description in conjunction with the accompanying drawings, in which:

FIG. 1 illustrates an apparatus for configuring devices in a network in accordance with one embodiment of the present principles;

FIG. 2 illustrates a method for configuring a device in accordance with one embodiment of the present principles;

FIG. 3 illustrates a method for configuring a device in accordance with one embodiment of the present principles.

To facilitate understanding, identical reference numerals have been used, where possible, to designate identical elements that are common to the figures.

### DETAILED DESCRIPTION

Embodiments of the invention provide a method and apparatus for configuring one or more devices in a facility within a network. One embodiment provides for automatically configuring a device by coupling a portable device to the device. The portable device contains information relevant to the configuration of the device, e.g., location information, which is retrieved by the device. Based on the location information, configuration information can be provided to, or obtained by, the device, which configures itself according to the configuration information.

In one embodiment, the device retrieves configuration information from storage (either local or remote) that is appropriate for the device's location (as identified by the location information from the first device), and proceeds to perform a self-configuration based on the configuration information. In another embodiment, the location information is sent by the device to a server. In response, the server sends configuration information to the device, which configures itself based on the configuration information.

Embodiments of the invention can generally be applied to different facilities, including a variety of establishments or installations, public or private venues. In one embodiment, the facility is a business establishment having a server for managing and delivering data or content to display equipment or terminals in the business establishment. In another embodiment, the facility is an establishment related to the distribution, storage, and/or sale of goods or services, e.g., warehouse, showrooms, shops, department stores, and so on. In yet another embodiment, the facility is a store with a server for managing and delivering content for retail advertising.

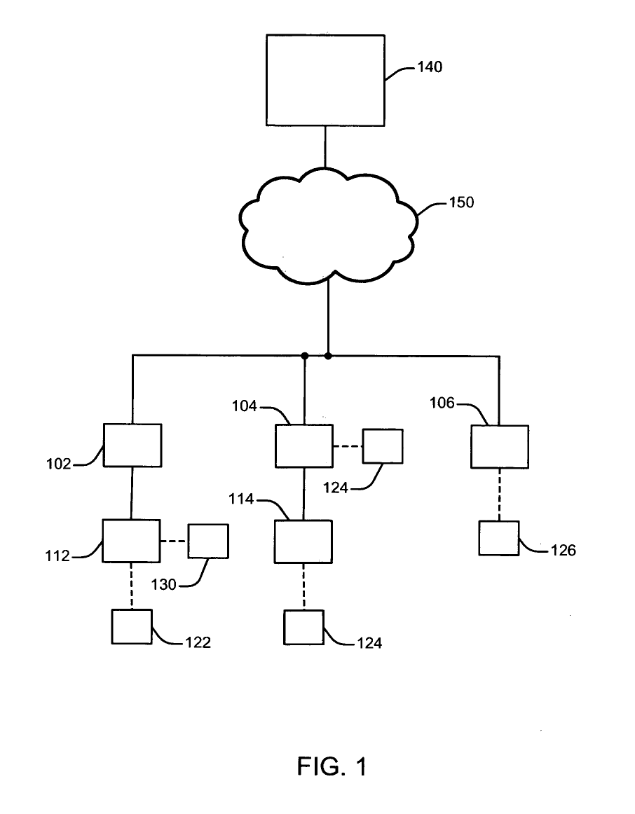

FIG. 1 illustrates one embodiment of the present invention for configuring one or more devices in a facility. In one embodiment, the devices are components in a media distribution system 100, which includes a server 140 operatively coupled to devices typically used for media distribution and display. This server may be local to the facility or venue, or if network connectivity is available, the server may be at a remote location. The server 140 may communicate with these devices via a network 150, e.g., wide area network (WAN), local area network (LAN), and so on.

In one example, the media distribution system 100 is a video display system such as those in an in-store advertising network, and representative devices 102, 104, 106, 112 and 114 may be a variety of devices typically used for content delivery and display, e.g., set-top boxes or receivers, video displays such as liquid crystal display (LCD) or plasma display, audio-related equipment such as decoders, amplifier, speakers, among others. The server 140 may be located at some remote location from a store, or in the same store as the configurable devices.

Devices 102 and 104 may be located in different departments in a facility, and may be set-top boxes (STB) or receivers with hardware and software configured for communicating with the server 140, and for receiving audio-visual information or data corresponding to media content. Devices 112 and 114 may be various components or equipment used for video display and/or audio playback. Device 106 may be yet another type of configurable device in another location within a facility and also configured for communicating with the server 140. In the context of this invention, devices 102, 104, 106, 112, and 114 are also referred to as “configurable” devices, whose configuration parameters can be set or determined based, in part, on information from the server 140.

The present invention provides one or more portable devices 122, 124 and 126 for coupling to respective configurable devices using wired or wireless connections. For example, portable devices 122, 124 and 126 may couple to one or more of the configurable devices via RS-232 serial ports, universal serial bus (USB), Bluetooth radio, or other appropriate communication ports or interfaces. A portable device, e.g., device 122, 124 or 126, contains information relevant to the configuration setup of at least one configurable device, including, for example, location information of the configurable device. For an in-store advertising system, media content for a screen location or department are usually specific to the products in the department. Thus, the configurations of media display devices are also dependent on the location of the devices within the store.

During installation, repair and/or re-configuration of a configurable device, a portable device such as device 122 is coupled to configurable device 112, e.g., by installation personnel. The configurable device 112 has software and/or processor (or the same functionality implemented in a hardware device such as an application specific integrated circuit (ASIC), field programmable gate array (FPGA) or other electronics that implements a set of logical activities) that reads and searches for information relevant to the configurable device, e.g., location information, or a signature that identifies a predetermined location code for the configurable device 112. The location code may indicate, for example, product categories or departments such as grocery, pharmacy, electronics, and so on. In other embodiments, the portable device 122 may be used for device installations in different facilities or geographical locations. Thus, location information relevant to device configurations may also include the type of facility or geographical location, e.g., a video display in a pharmacy department in one region may be configured differently from a display in another region.

After receiving relevant location information or code from the portable device, the configurable device 112 transmits the location information over the network 150. In one embodiment, the transmission may occur after the configurable device 112 has obtained a temporary IP address using dynamic host configuration protocol (DHCP), or using a broadcast or multicast address. The temporary IP address is used to facilitate the communications with a remote server. Using this temporary IF configuration, the device 112 can send a message with its location information over a multicast or broadcast protocol. One protocol suitable for this is the Device Group Control Protocol (DGCP), which is a very efficient network protocol that supports communications to a plurality of devices in groups. Details of the protocol are described in a published PCT patent application, WO 2008/123858 A1, “Device Group Control” filed on Jun. 13, 2007, which is herein incorporated by reference in its entirety.

Other embodiments may use alternative connectivity options to a central server, which include, for example, BlueTooth radio, ZigBee radio, serial connections, or other network technology where the configuration of the network itself is not part of the data being used to configure the location-based configuration.

Based on the location code from configurable device 112, the server 140 determines configuration information for device 112. For example, the server 140 may use a lookup table, database or other indexed means to determine a specific IP address and/or configuration parameters for the screen location of device 112. Since the device 112 (and other configurable devices) communicates with the server 140 in a manner that the server would know what type of device it is (e.g., video, audio, and so on) and what needs to be configured, the server 140 is able to reply with the proper configuration data for that particular device in that location. In some embodiments, the desired IP address of the device may be chosen based on location. One or more configuration messages can be sent by the server 140 to device 112 using DGCP or similar protocol. A configuration message may include information such as one or more configuration parameters and/or an assignment of the specific IP address for use by the device 112.

In yet another embodiment, the device 112 is provided with access to another device or component 130, including a storage medium. Component 130 may, for example, be a hard disc drive or other suitable storage, which has configuration information stored thereon. Such configuration information is similar to the information available to the server 140, e.g., including at least one configuration parameters suitable for device 112, and may include configuration information corresponding to a number of different locations in a facility. Based on the location information obtained from the portable device 122, the configurable device 112 can select the appropriate configuration information for the device's location. Alternatively, the storage medium or hard drive containing the configuration information may also be internal to the device 112.

The configurable device 112 can apply the configuration automatically according to the received information or parameters, i.e., configures itself using a processor and associated software on the device, without human intervention. Once configured, device 112 can begin to operate accordingly, for example, as a video display or other media devices in the media distribution system. Completion of the installation or automatic configuration of the device 112 may be indicated by subsequent proper operation of the device 112, e.g., a correct video being played out, or other indicators such as visual and/or audible cues (a light turning on or an audible tone). The portable device 122 can then be de-coupled from the configurable device 112.

If an RS-232 serial port on the configurable device 112 is used for coupling to the portable device, this same port can then be used to connect to other equipment in the media distribution system, and the system can also detect, control and/or configure the serial equipment according to normal procedure.

These portable devices can include different components and/or functionalities. For example, one embodiment may be a plug-in memory card where the memory stores the location code. Another embodiment may include a microprocessor, memory and an I/O device. Yet another embodiment may include a Radio Frequency ID card (RFID) that is read by the configurable device when in close proximity. Since these devices are relatively inexpensive, each installation team can have several portable devices for each location or facility, allowing a more efficient or speedy installation.

As previously mentioned, these portable devices can be used for device installations or configuration in different locations or departments within one facility, or in different facilities, as needed. In alternative implementations, a portable device containing location information for more than one departments or locations within a facility (instead of having a fixed location code), may be provided with a means to select from several location codes. Examples of this might include a selector switch or buttons that can be pressed to select between different location codes.

In another embodiment, the portable device 122 is a RS-232 plug with a small microcontroller attached to the SND and RCV lines. Another embodiment might be a small plug that connects to a parallel (printer) port. This device may be approximately the size of a coin, e.g., about 1 inch in diameter. Other configurations or designs suitable for portability are also acceptable. It can also be color coded, for example, to indicate the location code programmed into it. The microcontroller can periodically send a prescribed series of data bits by transmitting on the SND line. This series of bits may consist of a header indicating that the payload is a location code, followed by a payload with the location code. Software in the configurable device 112 can listen for such a transmission, and the location code transmitted by device 122 can be read by device 112.

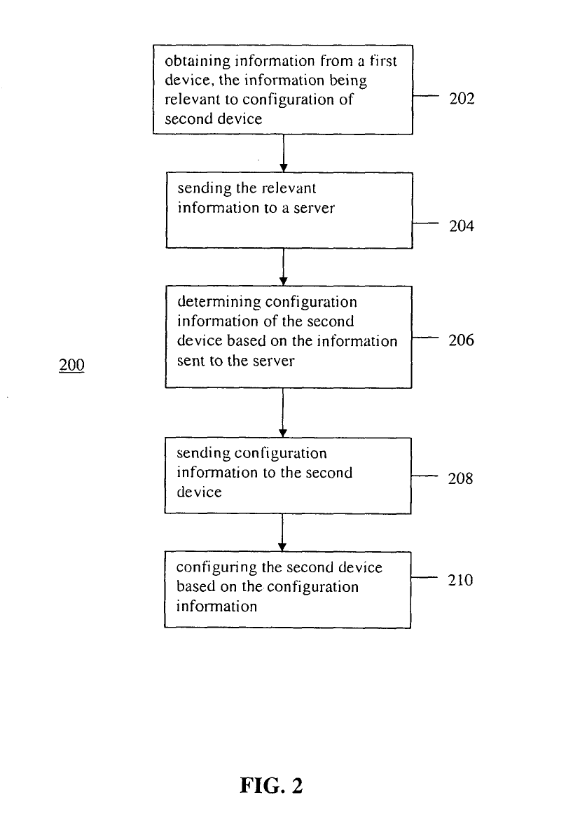

FIG. 2 is a schematic diagram illustrating a method 200 according to one embodiment of the present invention. The method allows for automatically configuring a device, without manually retrieving information and/or configuring the device.

In step 202, information stored on a first device (e.g., a portable device), which is relevant to configuring a second device (e.g., a configurable device), is accessed by the second device. The access may be enabled by operatively coupling the first device to the second device. In the context of the present invention, information relevant to configuring the second device includes any information that may affect or is used for determining the configuration of the device. Such information includes location of the configurable device, e.g., within a facility, or geographical location of the facility.

In step 204, the information relevant to configuration of the second device is sent by the second device to a server.

In step 206, configuration information for the configurable device is determined by the server based on the relevant information of the device. This determination may be done, for example, by the use of a lookup table or database, which lists at least one configuration parameter and/or a planned IP address for the device's location code.

In step 208, the configuration information for the second device is sent by the server and received by the second device.

In step 210, the second device is configured according to the received configuration information, e.g., through a self-configuration procedure performed by a processor on the device.

In another embodiment, the second (configurable) device is configured for obtaining the configuration information via other options, i.e., without sending the location information to the server. For example, the second device may be provided with appropriate software and/or hardware to interface directly with a different device or component (including local storage), which allows the configuration information to be retrieved by the second device based on the relevant information, e.g., location information, provided by the first device. Thereafter, the second device can again configure itself according to the configuration information that it retrieves from the third device.

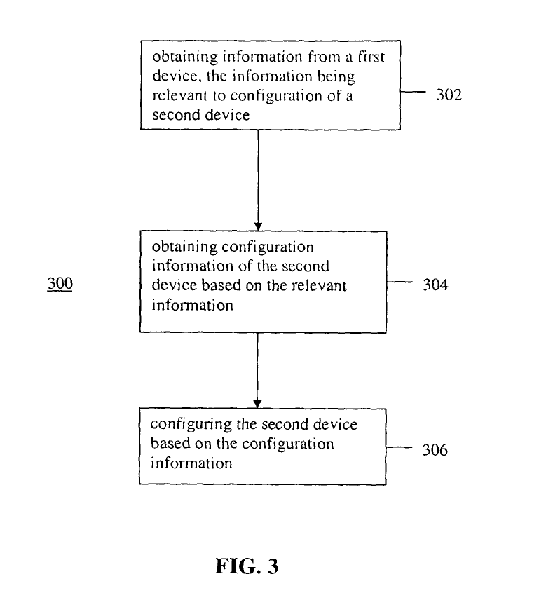

In yet another embodiment, the configurable device includes a hard disc or other suitable storage, which has configuration information for different locations already stored. Based on the information from the portable device, e.g., location information of the device, the device can obtain or select the proper configuration information from storage, and perform a self-configuration accordingly. This is illustrated in FIG. 3, which shows a method 300 for implementing another embodiment of this invention.

In step 302, information stored on a first device (e.g., a portable device), which is relevant to configuring a second device (e.g., a configurable device), is accessed by the second device. The access can be enabled by operatively coupling the first device to the second device. In the context of the present invention, information relevant to configuring the second device includes any information that may affect or is used for determining the configuration of the device. In one embodiment, the information from the first device includes location (e.g., in form of a location code) of the configurable device, e.g., within a facility, or geographical location of the facility.

In step 304, configuration information for the second device is determined based on the relevant information, e.g., location, of the device. This determination may be done, for example, by the use of a lookup table or database, which lists at least one configuration parameter and/or a planned IF address for the device. In one example, the second device accesses a local storage (e.g., its own hard disc or other storage medium, or another memory accessible to the second device) that has configuration information stored therein, which may include configuration information for different locations. Based on its location information, the second device can obtain or select the proper configuration information.

In step 306, the second device is configured according to the configuration information, e.g., through a self-configuration procedure performed by a processor on the device.

Embodiments of the present principles allow installations to be done with reduced errors and in shorter time. Since the configuration is automatically done, with the configurable device performing data retrieval, transmission and self-configuration, human errors can be minimized, resulting in reduced cost and improved installation rate.

While the forgoing is directed to various embodiments of the present invention, other and further embodiments of the invention may be devised without departing from the basic scope thereof. As such, the appropriate scope of the invention is to be determined according to the claims, which follow.

1. A method, comprising:
(a) obtaining information from a first device, the information being relevant to configuration of a second device;
(b) obtaining configuration information of the second device based on the relevant information of the second device; and
(c) configuring the second device according to the configuration information.

2. The method of claim 1, wherein steps (a), (b) and (c) are performed by the second device.

3. The method of claim 1, wherein the information relevant to configuration of the second device includes location information of the second device.

4. The method of claim 1, wherein step (b) further comprises the second device retrieving the configuration information from a storage medium.

5. The method of claim 1, wherein step (b) further comprises sending the relevant information to a server, and the server generating the configuration information.

6. The method of claim 1, wherein step (a) further comprises coupling the first device to the second device by serial communication.

7. The method of claim 1, wherein the first device is a portable device.

8. The method of claim 1, wherein the first device comprises a memory and an input-output interface.

9. The method of claim 1, wherein the second device is a display device in an advertising system.

10. A system, comprising:
a first device containing information relevant to configuration of a second device; and
the second device for obtaining the relevant information contained in the first device, and for performing self-configuration based at least on the relevant information.

11. The system of claim 10, wherein the information relevant to configuration of the second device includes location information of the second device.

12. The system of claim 10, further comprising:
a storage medium containing configuration information for the second device; and
the second device further configured for retrieving the configuration information from the storage medium for performing the self-configuration.

13. The system of claim 10, wherein the first device is a portable device.

14. The method of claim 10, wherein the first device includes a microcontroller.

15. The system of claim 10, wherein the second device includes a processor and software for performing the self-configuration.

16. The system of claim 10, wherein the first device includes a serial communication interface.

17. The system of claim 10, further comprising:
a server for providing configuration information to the second device based on the relevant information.

18. The system of claim 10, wherein the second device is a display device in an advertising system.
